(19) United States
(12) Patent Application Publication
(10) Pub. No.: US 2021/0333921 A1
(43) Pub. Date: Oct. 28, 2021

(54) DISPLAY DEVICE, MULTI-FINGERPRINT DETECTION DEVICE AND OPERATION METHOD THEREOF

(71) Applicant: Novatek Microelectronics Corp., Hsinchu (TW)

(72) Inventors: Yi-Ting Chung, Hsinchu County (TW); Hsing-Lung Chung, Miaoli County (TW); Ding-Teng Shih, Taoyuan City (TW); Bo-Jun Peng, New Taipei City (TW)

(73) Assignee: Novatek Microelectronics Corp., Hsinchu (TW)

(21) Appl. No.: 16/860,082

(22) Filed: Apr. 28, 2020

(51) Int. Cl. G06F 3/041; G06K 9/00

(52) U.S. Cl. CPC G06F 3/0416; G06F 2203/04104; G06K 9/00013

(57) ABSTRACT

A display device, a multi-fingerprint detection device and an operation method thereof are provided. The multi-fingerprint detection device includes a touch circuit and a fingerprint sensing control circuit. The touch circuit performs touch detection control on a touch panel module to determine a plurality of touch regions of a touch event on the touch panel module. The fingerprint sensing control circuit performs fingerprint sensing control on the touch panel module, so that the touch panel module senses a plurality of target sub-regions corresponding to the touch regions, and then obtains fingerprint sensing result of the target sub-regions. The fingerprint sensing control circuit divides the fingerprint sensing result into a plurality of sub-fingerprint images according to the touch regions.

### BACKGROUND

### Field of the Disclosure

The disclosure relates to an electronic device, and in particular to a display device, a multi-fingerprint detection device and an operation method thereof.

### Description of Related Art

A fingerprint sensor can be placed on a display panel. Alternatively, the fingerprint sensor can be placed under the display panel. Or, the fingerprint sensor can be embedded in the display panel. Therefore, a part (or all) of the display region of the display panel can be used as a fingerprint sensing region in order to sense fingerprints. Generally speaking, the larger the area of the fingerprint sensing region, the higher the user's freedom of operation. The fingerprint sensing region (fingerprint sensor) has multiple fingerprint sensing units (sensing pixels). When the user's finger is pressed anywhere on the fingerprint sensing region of the display panel, the fingerprint sensor can sense the fingerprint of the user's finger.

Generally speaking, the fingerprint sensing region of the existing display panel can only sense the fingerprint of one finger at a time. When multiple fingers touch the display panel simultaneously, the existing fingerprint detection device cannot drive the fingerprint sensor to simultaneously sense the fingerprints of the multiple fingers. That is, the existing fingerprint detection device cannot perform multi-fingerprint detection.

Furthermore, when the user's finger touches the display panel to perform fingerprint registration, the existing fingerprint detection device can notify the user that the fingerprint registration currently performed has been completed. However, the existing fingerprint detection device cannot prompt the recognition processing progress value (current status) to the user before completing the fingerprint registration. Therefore, users have no idea about the processing progress (current status) of the currently performed fingerprint registration before completing the fingerprint registration.

When performing fingerprint registration, the existing fingerprint detection device cannot prompt the feature-insufficiency part (the portion to which feature points need to be added) of the fingerprint image to the user. For example, when the user touches the display panel with a fingertip, the existing fingerprint detection device can sense the fingerprint image of the fingertip. In general, there are more fingerprint feature points on the finger pulp. After the existing fingerprint detection device obtains the fingerprint image of the fingertip, the fingerprint detection device will not prompt the user to touch the display panel with the finger pulp instead.

It should be noted that the content of the section “Related Art” is used to help understand the present disclosure. Part of the content (or the entire content) disclosed in the section “Related Art” may not be the conventional technology known to those with ordinary knowledge in the technical field. The content disclosed in the section “Related Art” does not mean that the content has been known by those with ordinary knowledge in the technical field before the application of the present disclosure.

### SUMMARY OF THE DISCLOSURE

The disclosure provides a multi-fingerprint detection device and an operation method thereof, which can perform multi-fingerprint detection. The disclosure provides a display device that can display the recognition processing progress value and (or) the prompt information corresponding to the feature-insufficiency part on the touch panel module.

In an embodiment of the disclosure, the multi-fingerprint detection device includes a touch circuit and a fingerprint sensing control circuit. The touch circuit is configured to perform touch detection control on the touch panel module to determine multiple touch regions of a touch event on the touch panel module. The fingerprint sensing control circuit is configured to perform fingerprint sensing control on the touch panel module, so that the touch panel module senses multiple target sub-regions corresponding to these touch regions, and then obtains the fingerprint sensing result of the target sub-regions. The fingerprint sensing control circuit divides the fingerprint sensing result into multiple sub-fingerprint images according to these touch regions.

In an embodiment of the disclosure, the operation method includes: performing touch detection control on the touch panel module to determine multiple touch regions of the touch event on the touch panel module; performing fingerprint sensing control on the touch panel module, so that the touch panel module senses multiple target sub-regions corresponding to these touch regions, thereby obtaining fingerprint sensing result of these target sub-regions; and dividing the fingerprint sensing result into multiple sub-fingerprint images according to these touch regions.

In an embodiment of the disclosure, the display device includes a touch panel module, a display driving circuit, a fingerprint sensing control circuit, and an application processor. The display driving circuit is configured to drive the touch panel module to display images on the touch panel module. The fingerprint sensing control circuit is configured to perform fingerprint sensing control on the touch panel module. The application processor is coupled to the fingerprint sensing control circuit to receive at least one fingerprint sensing result. The application processor processes the at least one fingerprint sensing result to obtain the recognition processing progress value. The application processor displays the recognition processing progress value of the at least one fingerprint sensing result on the touch panel module through the display driving circuit.

In an embodiment of the disclosure, the display device includes a touch panel module, a display driving circuit, a touch circuit, a fingerprint sensing control circuit, and an application processor. The display driving circuit is configured to drive the touch panel module to display images on the touch panel module. The touch circuit is configured to perform touch detection control on the touch panel module to determine at least one touch region of the touch event on the touch panel module. The fingerprint sensing control circuit is configured to perform fingerprint sensing control on the touch panel module. The application processor is coupled to the touch circuit to receive touch information of the at least one touch region. The application processor is coupled to the fingerprint sensing control circuit to receive at least one fingerprint sensing result. The application processor determines the feature-insufficiency part of the at least one fingerprint sensing result according to the at least one touch region. The application processor displays the prompt information corresponding to the feature-insufficiency part on the touch panel module through the display driving circuit.

Based on the above, the multi-fingerprint detection device and the operation method thereof according to the embodiments of the disclosure can determine multiple touch regions of the touch event on the touch panel module and sense multiple target sub-regions corresponding to the touch regions to obtain the fingerprint sensing result. The multi-fingerprint detection device can divide the fingerprint sensing result into multiple sub-fingerprint images according to these touch regions. Therefore, the multi-fingerprint detection device can perform multi-fingerprint detection. The display devices described in the embodiments of the disclosure can display the recognition processing progress value and (or) the prompt information corresponding to the feature-insufficiency part on the touch panel module.

In order to make the above-mentioned features and advantages of the present invention more obvious and understandable, the embodiments are specifically described below in detail in conjunction with the accompanying drawings.

### BRIEF DESCRIPTION OF THE DRAWINGS

FIG. 1 is a schematic circuit block diagram of a display device according to an embodiment of the disclosure.

FIG. 2 is a schematic flowchart diagram illustrating an operation method of a multi-fingerprint detection device according to an embodiment of the disclosure.

FIG. 3 is a schematic diagram illustrating a scenario where the touch panel module shown in FIG. 1 performs fingerprint sensing according to an embodiment of the disclosure.

FIG. 4 is a schematic diagram illustrating a scenario where the touch panel module shown in FIG. 1 performs fingerprint sensing according to another embodiment of the disclosure.

FIG. 5 is a schematic flowchart diagram illustrating an operation method of a multi-fingerprint detection device according to another embodiment of the disclosure.

FIG. 6 is a schematic diagram illustrating a scenario where the touch panel module shown in FIG. 1 performs fingerprint sensing according to still another embodiment of the disclosure.

FIG. 7 is a schematic diagram illustrating an application scenario where the touch panel module shown in FIG. 1 performs fingerprint registration according to an embodiment of the disclosure.

FIG. 8A and FIG. 8B are schematic diagrams illustrating pictures displayed by the touch panel module shown in FIG. 1 in different application scenarios according to embodiments of the disclosure.

### DESCRIPTION OF EMBODIMENTS

The term “coupling/coupled” used in this specification (including claims) may refer to any direct or indirect connection means. For example, “a first device is coupled to a second device” should be interpreted as “the first device is directly connected to the second device” or “the first device is indirectly connected to the second device through other devices or connection means.” Terms such as “first” and “second” mentioned in the specification or the claims are only for naming the elements or distinguishing different embodiments or scopes and are not intended to limit the upper limit or the lower limit of the number of the elements or to limit the order the elements. Moreover, wherever appropriate in the drawings and embodiments, elements/components/steps with the same reference numerals represent the same or similar parts. Elements/components/steps with the same reference numerals or names in different embodiments may be cross-referenced.

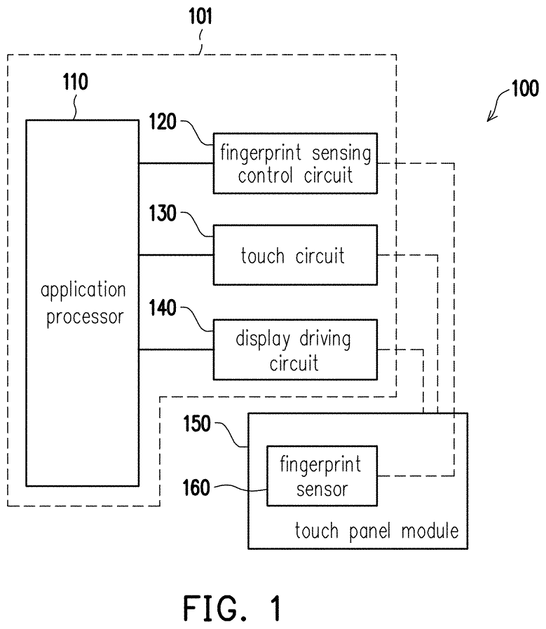

FIG. 1 is a schematic circuit block diagram of a display device 100 according to an embodiment of the disclosure. The display device 100 may be a mobile device or other non-mobile computing device. The display device 100 may include a multi-fingerprint detection device 101 and a touch panel module 150. Based on design requirements, in some embodiments, the multi-fingerprint detection device 101 may include an application processor 110, a fingerprint sensing control circuit 120 and a touch circuit 130, and the touch panel module 150 may include a touch panel with touch detection function and fingerprint sensing function. The touch panel module 150 may include a touch detector (not shown). The touch circuit 130 can perform touch detection control on the touch panel (touch panel module 150) to determine one or more touch regions of a touch event on the touch panel. Then, the touch circuit 130 can provide the information corresponding to these touch regions to the application processor 110.

The implementation details of the touch panel module 150 can be determined according to the design requirements. The touch panel module 150 also includes a fingerprint sensor 160. Based on design requirements, the fingerprint sensor 160 may be an optical fingerprint sensor or other fingerprint sensors, such as a capacitive fingerprint sensor. The fingerprint sensor 160 can be placed under the touch panel module 150. Alternatively, the fingerprint sensor 160 may be embedded inside the touch panel module 150. For example, the fingerprint sensor 160 may be arranged through one of on-display configuration, under-display configuration, local in-display configuration, and global in-display configuration. Alternatively, the fingerprint sensor 160 may be arranged in other configurations. Therefore, a part (or all) of the display region of the touch panel module 150 can be used as the fingerprint sensing region of the fingerprint sensor 160 to facilitate fingerprint sensing. Generally speaking, the larger the area of the fingerprint sensing region, the higher the user's freedom of operation.

The fingerprint sensing region (fingerprint sensor 160) of the touch panel module 150 may have multiple fingerprint sensing units (sensing pixels). The fingerprint sensing unit can be arranged in the same layer structure as the display pixel unit, or in a different layer structure. When arranged in the same layer structure, the fingerprint sensing unit can be interlaced with the display pixel unit, for example, one or several rows of display pixel units collocate with one or several rows of fingerprint sensing units, or they are arranged in different blocks without being configured in an alternate manner. When the user's finger is pressed anywhere in the fingerprint sensing region of the touch panel module 150, the fingerprint sensor 160 can sense the fingerprint of the user's finger.

The fingerprint sensing control circuit 120 can be coupled (directly or indirectly connected) to the fingerprint sensor 160 of the touch panel module 150 to perform fingerprint sensing control on the touch panel module 150. For example, the fingerprint sensing control circuit 120 can make the touch panel module 150 to sense multiple target sub-regions corresponding to these touch regions, and then obtain the fingerprint sensing result of these target sub-regions. The fingerprint sensing control circuit 120 can divide the fingerprint sensing result into multiple sub-fingerprint images according to these touch regions, and then provide these sub-fingerprint images (fingerprint sensing result) to the application processor 110.

Based on design requirements, in still other embodiments, the touch panel module 150 may include a touch display panel with a display function, a touch detection function, and a fingerprint sensing function, and the multi-fingerprint detection device 101 may include the application processor 110, the fingerprint sensing control circuit 120, the touch circuit 130, and the display driving circuit 140. The application processor 110 may be coupled to the display driving circuit 140 to provide image frames. The display driving circuit 140 can be coupled (directly or indirectly connected) to the touch panel module 150. The display driving circuit 140 can drive/control the display panel (touch panel module 150) to display images on the display panel. For example, the touch panel module 150 may include an integrated gate driver on array (GOA) circuit (not shown), and the display driver circuit 140 may communicate with the GOA circuit of the touch panel module 150 to control the touch panel module 150.

It should be noted that although the fingerprint sensing control circuit 120, the touch circuit 130, and the display driving circuit 140 are shown as different circuit blocks, each block, a part or all of which, may be partially or completely integrated with another one (or another two). Based on design requirements, the fingerprint sensing control circuit 120, the touch circuit 130 and the display driving circuit 140 may be partially or completely integrated into a single chip or separated into different chips. For example, in some embodiments, the fingerprint sensing control circuit 120, the touch circuit 130, and the display driving circuit 140 may be different integrated circuits. In other embodiments, the touch circuit 130 and the display driver circuit 140 can be integrated into a Touch with Display Driver integration (TDDI) chip (or TDDI integrated circuit), and the fingerprint sensing control circuit 120 is implemented in another chip (or integrated circuit). For example, the touch panel module 150 may include a TDDI GOA circuit (not shown), and the TDDI chip (or TDDI integrated circuit) may communicate with the TDDI GOA circuit to control touch and display operations on the touch panel module 150. In still other embodiments, the fingerprint sensing control circuit 120, the touch circuit 130 and the display driving circuit 140 can be integrated into a single integrated circuit.

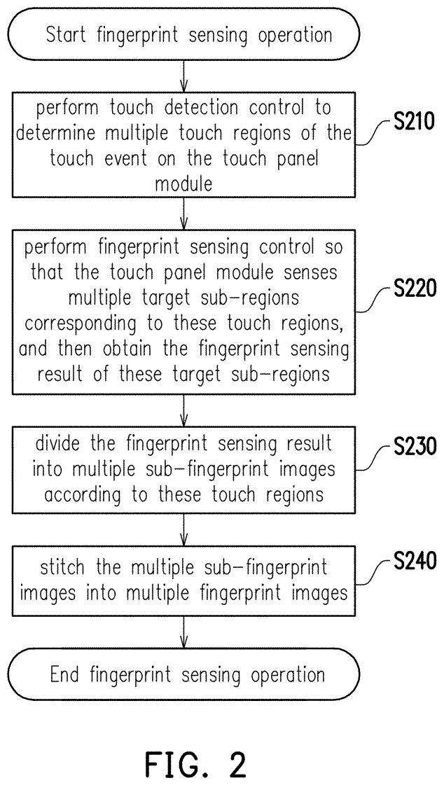

FIG. 2 is a schematic flowchart diagram illustrating an operation method of a multi-fingerprint detection device 101 according to an embodiment of the disclosure. Please refer to FIG. 1 and FIG. 2. In step S210, the touch circuit 130 can perform touch detection control on the touch panel module 150 to determine multiple touch regions of the touch event on the touch panel module 150. This embodiment provides no limitation to the implementation details of the touch detection performed in step S210. Based on design requirements, in some embodiments, the touch detection performed in step S210 may include conventional touch detection or other touch detection.

In step S220, the fingerprint sensing control circuit 120 may perform fingerprint sensing control on the touch panel module 150, so that the touch panel module 150 senses multiple target sub-regions corresponding to these touch regions, and then obtain the fingerprint sensing result of these target sub-regions. The fingerprint sensing result is, for example, a fingerprint image frame containing the target sub-regions, or raw data of the fingerprint image of the target sub-regions. The determining method of these target sub-regions can be different according to the design requirements. The following will explain the determining method of these target sub-regions with different embodiments.

For example, in some embodiments, the fingerprint sensing region of the touch panel module 150 may be divided into multiple sub-regions. FIG. 3 is a schematic diagram illustrating a scenario where the touch panel module 150 shown in FIG. 1 performs fingerprint sensing according to an embodiment of the disclosure. Please refer to FIG. 1 and FIG. 3. In the embodiment shown in FIG. 3, the fingerprint sensing region 161 of the touch panel module 150 can be divided into sub-regions SR1, SR2, SR3, SR4, SR5, SR6, SR7, SR8, SR9, SR10, SR11 and SR12. It is assumed here that two fingers simultaneously touch the touch panel module 150. The touch circuit 130 can perform touch detection control on the touch panel module 150 to determine the touch regions 131 and 132 of the touch event on the touch panel module 150. The application processor 110 is coupled to the touch circuit 130 to receive the touch information corresponding to the touch regions 131 and 132.

In some embodiments, the fingerprint sensing control circuit 120 may obtain a touch region command corresponding to the touch information from the application processor 110, wherein the touch region command includes information about position coordinate and area size of the touch regions 131 and 132. The fingerprint sensing control circuit 120 can select at least one of the sub-regions SR1 to SR12 of the fingerprint sensing region 161 as the target sub-region according to the touch region command. Taking the scenario shown in FIG. 3 as an example, since the touch region 131 extends into the sub-regions SR1, SR2, SR4, and SR5, and the touch region 132 extends into the sub-regions SR8, SR9, SR11, and SR12, the fingerprint sensing control circuit 120 may select the sub-regions SR1, SR2, SR4, SR5, SR8, SR9, SR11 and SR12 as the target sub-region.

In other embodiments, the fingerprint sensing control circuit 120 may be coupled to the touch circuit 130 to obtain touch information of the touch regions 131 and 132, wherein the touch information includes information about the position coordinate and area size of the touch regions 131 and 132. The fingerprint sensing control circuit 120 can select at least one of the sub-regions SR1 to SR12 of the fingerprint sensing region 161 as the target sub-region according to the touch information of the touch regions 131 and 132. Taking the scenario shown in FIG. 3 as an example, based on the touch regions 131 and 132, the fingerprint sensing control circuit 120 can select the sub-regions SR1, SR2, SR4, SR5, SR8, SR9, SR11, and SR12 as the target sub-regions.

In still other embodiments, based on the touch information of the touch region provided by the touch circuit 130, the application processor 110 may select the target sub-region overlapped by the touch regions from the sub-regions of the fingerprint sensing region, and provide the information about the target sub-region to the fingerprint sensing control circuit 120. Taking the scenario shown in FIG. 3 as an example, the application processor 110 can select the sub-regions SR1, SR2, SR4, SR5, SR8, SR9, SR11 and SR12 overlapped by the touch regions 131 and 132 from the sub-regions SR1 to SR12 of the fingerprint sensing region 161 as the target sub-region, and provide the information about the target sub-region to the fingerprint sensing control circuit 120. The fingerprint sensing control circuit 120 can perform fingerprint sensing on the target sub-regions SR1, SR2, SR4, SR5, SR8, SR9, SR11 and SR12 according to the information provided by the application processor 110.

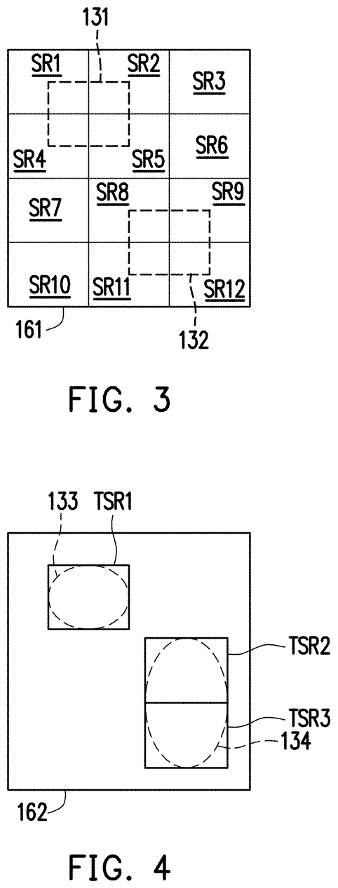

In some embodiments, the fingerprint sensing region of the touch panel module 150 may not be divided into multiple sub-regions. For example, FIG. 4 is a schematic diagram illustrating a scenario where the touch panel module 150 shown in FIG. 1 performs fingerprint sensing according to another embodiment of the disclosure. Please refer to FIG. 1 and FIG. 4. In the embodiment shown in FIG. 4, the fingerprint sensing region 162 of the touch panel module 150 is not divided into multiple sub-regions. It is assumed here that two fingers simultaneously touch the touch panel module 150. The touch circuit 130 can perform touch detection control on the touch panel module 150 to determine the touch regions 133 and 134 of the touch event on the touch panel module 150. The application processor 110 is coupled to the touch circuit 130 to receive the touch information corresponding to the touch regions 133 and 134.

In some embodiments, the fingerprint sensing control circuit 120 may obtain a touch region command corresponding to the touch information from the application processor 110, wherein the touch region command includes information about position coordinate and area size of the touch regions 133 and 134. The fingerprint sensing control circuit 120 can determine the target sub-region from the fingerprint sensing region 162 of the touch panel module 150 according to the touch region command. Taking the scenario shown in FIG. 4 as an example, the fingerprint sensing control circuit 120 can determine the target sub-regions TSR1, TSR2 and TSR3 from the fingerprint sensing region 162 of the touch panel module 150 according to the touch regions 133 and 134.

In other embodiments, the fingerprint sensing control circuit 120 may be coupled to the touch circuit 130 to obtain touch information of the touch regions 133 and 134, wherein the touch information includes information about the location coordinate and area size the touch regions 133 and 134. The fingerprint sensing control circuit 120 can determine the target sub-regions TSR1, TSR2 and TSR3 from the fingerprint sensing region 162 of the touch panel module 150 according to the touch information of the touch regions 133 and 134.

In still other embodiments, based on the touch information of the touch region provided by the touch circuit 130, the application processor 110 can determine the target sub-region from the fingerprint sensing region of the touch panel module 150, and provide the information about the target sub-region to the fingerprint sensing control circuit 120. Taking the scenario shown in FIG. 4 as an example, the application processor 110 can determine the target sub-regions TSR1, TSR2 and TSR3 from the fingerprint sensing region 162 of the touch panel module 150 according to the touch information of the touch regions 133 and 134, and provide the information of the target sub-regions TSR1, TSR2 and TSR3 to the fingerprint sensing control circuit 120. The fingerprint sensing control circuit 120 can perform fingerprint sensing on the target sub-regions TSR1, TSR2 and TSR3 according to the information provided by the application processor 110 to obtain multiple sub-fingerprint images corresponding to the target sub-regions TSR1, TSR2 and TSR3.

Please refer to FIG. 1 and FIG. 2. In step S220, the fingerprint sensing control circuit 120 may perform fingerprint sensing control on the touch panel module 150, so that the touch panel module 150 senses multiple target sub-regions corresponding to these touch regions, and then obtain the fingerprint sensing result of these target sub-regions. Based on design requirements, the fingerprint sensing result is, for example, a fingerprint image frame containing the target sub-regions, or raw data of the fingerprint image of the target sub-regions. In step S230, the fingerprint sensing control circuit 120 (or the application processor 110) may divide the fingerprint sensing result into multiple sub-fingerprint images according to these touch regions.

The application processor 110 is coupled to the fingerprint sensing control circuit 120 to receive these sub-fingerprint images. In step S240, the application processor 110 can stitch (splice) the sub-fingerprint images into multiple fingerprint images according to the touch regions. For example, a fingerprint sensing region of the touch panel module 150 is divided into multiple sub-regions, the application processor 110 selects the multiple target sub-regions overlapped by the multiple touch regions from the multiple sub-regions of the fingerprint sensing region, and the application processor 110 stitches the multiple sub-fingerprint images of the multiple target sub-regions overlapped by the multiple touch regions into multiple fingerprint images. This embodiment provides no limitation to the algorithm of image stitching performed in step S240. Based on design requirements, in some embodiments, the image stitching algorithm performed in step S240 may include a conventional fingerprint image stitching algorithm or other image stitching algorithms.

Based on the above, the multi-fingerprint detection device 101 and the operation method thereof described in this embodiment can determine multiple touch regions of the touch event on the touch panel module 150, and sense multiple target sub-regions corresponding to the touch regions to obtain the fingerprint sensing result. The multi-fingerprint detection device 101 can divide the fingerprint sensing result into multiple sub-fingerprint images according to these touch regions. Then, the multi-fingerprint detection device 101 can stitch the sub-fingerprint images of the multiple target sub-regions overlapped by the multiple touch regions into multiple fingerprint images according to the touch regions of the touch event. Therefore, the multi-fingerprint detection device 101 can perform multi-fingerprint detection.

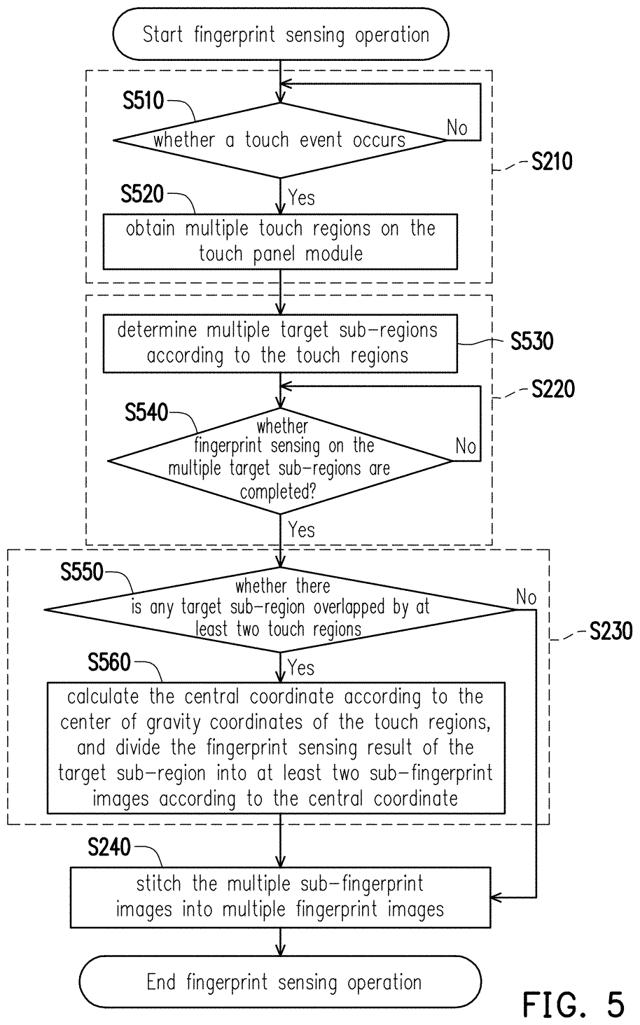

FIG. 5 is a schematic flowchart diagram illustrating an operation method of a multi-fingerprint detection device 101 according to another embodiment of the disclosure. The steps S210, S220, S230 and S240 in FIG. 5 can be analogized with reference to the relevant description in FIG. 2, so related description will not be repeated here. Please refer to FIG. 1 and FIG. 5. The step S210 in FIG. 5 includes steps S510 and S520. In step S510, the touch circuit 130 can perform touch detection control on the touch panel module 150 to determine whether a touch event occurs on the touch panel module 150. When a touch event occurs (the determining result of step S510 is “Yes”), the application processor 110 and the touch circuit 130 may proceed to step S520. In step S520, the application processor 110 may obtain one or more touch regions of the touch event on the touch panel module 150 through the touch circuit 130.

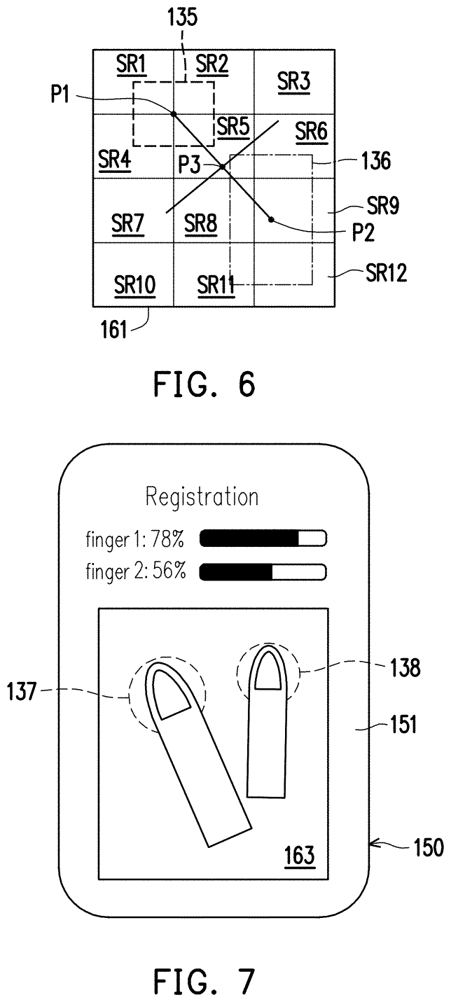

For example, in some embodiments, the fingerprint sensing region of the touch panel module 150 may be divided into multiple sub-regions. FIG. 6 is a schematic diagram illustrating a scenario where the touch panel module 150 shown in FIG. 1 performs fingerprint sensing according to still another embodiment of the disclosure. Please refer to FIG. 1 and FIG. 6. In the embodiment shown in FIG. 6, the fingerprint sensing region 161 of the touch panel module 150 can be divided into sub-regions SR1 to SR12. It is assumed here that two fingers simultaneously touch the touch panel module 150. The touch circuit 130 can perform touch detection control on the touch panel module 150 to determine the touch regions 135 and 136 of the touch event on the touch panel module 150. The application processor 110 is coupled to the touch circuit 130 to receive the touch information corresponding to the touch regions 135 and 136.

Please refer to FIG. 1 and FIG. 5. The step S220 in FIG. 5 includes steps S530 and S540. In step S530, the application processor 110 and (or) the fingerprint sensing control circuit 120 can determine multiple target sub-regions according to the touch regions 135 and 136. Taking the scenario shown in FIG. 6 as an example, because the touch region 135 extends into the sub-regions SR1, SR2, SR4, and SR5, and the touch region 136 extends into the sub-regions SR5, SR6, SR8, SR9, SR11, and SR12, the application processor 110 and (or) the fingerprint sensing control circuit 120 may select the sub-regions SR1, SR2, SR4, SR5, SR6, SR8, SR9, SR11 and SR12 as the target sub-region. In step S540, the fingerprint sensing control circuit 120 may perform fingerprint sensing on these target sub-regions. When the fingerprint sensing on these target sub-regions has been completed (the determining result of step S540 is “Yes”), the fingerprint sensing control circuit 120 may proceed to step S230.

The step S230 in FIG. 5 includes steps S550 and S560. In step S550, the fingerprint sensing control circuit 120 can find out from these target sub-regions whether there is the same target sub-region overlapped by at least two touch regions. When at least two touch regions of the touch regions overlap the same one target sub-region of the target sub-regions (the determining result of step S550 is “Yes”), the fingerprint sensing control circuit 120 can execute step S560. In step S560, the fingerprint sensing control circuit 120 may calculate the central coordinate of the center of gravity coordinates according to the center of gravity coordinates of the at least two touch regions, and the fingerprint sensing control circuit 120 may divide the fingerprint sensing result of the same target sub-region into at least two sub-fingerprint images according to the central coordinate.

For example, in the embodiment shown in FIG. 6, the touch regions 135 and 136 mutually overlap the same one target sub-region SR5 of the target sub-regions. According to the center of gravity P1 of the touch region 135 and the center of gravity P2 of the touch region 136, the fingerprint sensing control circuit 120 can calculate the central coordinate P3 between these center of gravity coordinates P1 and P2. The fingerprint sensing control circuit 120 can divide the fingerprint sensing result of the same target sub-region SR5 into at least two sub-fingerprint images (left and right parts of the sub-region SR5) according to the central coordinate P3.

Assuming that the starting coordinate of the upper left corner of the fingerprint sensing region 161 is (0,0), the center of gravity coordinate P1 is (199,159), the area of the touch region 135 is 200*160, and the center of gravity coordinate P2 is (459,429), and the area of the touch region 136 is 200*320. The coordinates of the upper left corner and the lower right corner of the touch region 135 are (99,79) and (299,239). The coordinates of the upper left corner and the lower right corner of the touch region 136 are (359,269) and (559,589). The coordinates of the upper left corner and lower right corner of the sub-region SR5 are (199,159) and (399,319). The central coordinate P3 is (329,294). The fingerprint sensing result of the sub-region SR5 can be divided into a left part and a right part with the central coordinate P3 as the boundary, wherein the coordinates of four vertices of the left part are (199,159), (199,319), (329,159) (329,319) respectively, the coordinates of four vertices of the right part are (329,159), (329,319), (399,159) and (399,319) respectively.

The fingerprint sensing result (fingerprint information) on the left part of the sub-region SR5 can be regarded as the fingerprint information on the lower right of the touch region 135. The fingerprint sensing result (fingerprint information) on the right part of the sub-region SR5 can be regarded as the fingerprint information on the upper left of the touch region 136. After dividing the fingerprint sensing result of the target sub-region SR5 into two sub-fingerprint images, the application processor 110 can stitch (splice) the sub-fingerprint image of the sub-region SR1, the sub-fingerprint image of the sub-region SR2, the sub-fingerprint image of the sub-region SR4, and the sub-fingerprint image on the left part of the sub-region SR5 into the fingerprint image of the touch region 135. In addition, the application processor 110 can stitch (splice) the sub-fingerprint image on the right part of the sub-region SR5, the sub-fingerprint image of the sub-region SR6, the sub-fingerprint image of the sub-region SR8, the sub-fingerprint image of the sub-region SR9, the sub-fingerprint image of the sub-region SR11, and the sub-fingerprint image on the left part of the sub-region SR12 into the fingerprint image of the touch region 136.

FIG. 7 is a schematic diagram illustrating an application scenario where the touch panel module 150 shown in FIG. 1 performs fingerprint registration according to an embodiment of the disclosure. In the embodiment shown in FIG. 7, the touch panel module 150 has a display region 151. A part (or all) of the display region 151 can be used as the fingerprint sensing region 163 of the fingerprint sensor 160 to facilitate fingerprint sensing. For the fingerprint sensing region 163 shown in FIG. 7, reference may be made to related description of the fingerprint sensing region 161 shown in FIG. 3 and (or) FIG. 6, and (or) related description of the fingerprint sensing region 162 shown in FIG. 4, so no repetition is incorporated herein.

In the application scenario shown in FIG. 7, the two fingers (marked as “finger 1” and “finger 2” respectively) of the user are respectively in contact with the touch regions 137 and 138 of the touch panel module 150. Description of the touch regions 137 and 138 shown in FIG. 7 can be derived from the related descriptions of the touch regions 131 and 132 shown in FIG. 3, and (or) from the related descriptions of the touch regions 133 and 134 shown in FIG. 4, and (or) from the relevant descriptions of the touch regions 135 and 136 shown in FIG. 6. Therefore, no repetition is incorporated herein.

Please refer to FIG. 1 and FIG. 7. The application processor 110 is coupled to the fingerprint sensing control circuit 120 to receive multiple sub-fingerprint images corresponding to the touch regions 137 and 138. The application processor 110 can stitch (splice) the sub-fingerprint images into multiple fingerprint images (fingerprint image of “finger 1” and fingerprint image of “finger 2”) according to the touch regions 137 and 138. The application processor 110 can process any of these fingerprint images to obtain the recognition processing progress value. The application processor 110 can display the recognition processing progress value of these fingerprint images on the display region 151 of the touch panel module 150 (as shown in FIG. 7), so as to notify the user. The user can view the recognition processing progress value to know the processing progress of fingerprint registration.

The recognition processing progress value can be defined according to design requirements. For example, in some embodiments, the recognition processing progress value includes the ratio of the number of feature points of any of these fingerprint images to the threshold value. This embodiment provides no limitation to the algorithm of “extracting feature points from one fingerprint image”. For example, the application processor 110 can execute a conventional algorithm or other algorithms to extract feature points from one fingerprint image.

Based on design requirements, the application processor 110 can also notify the user of the feature-insufficiency part of current fingerprint registration by sound, light, image or other media. For example, when the user touches the fingerprint sensing region 163 with a fingertip, the application processor 110 can extract the feature points from the fingerprint image of the fingertip. In general, there are more fingerprint feature points on the finger pulp. After obtaining the feature points of the fingerprint image of the fingertip, the application processor 110 can also prompt the user to touch the fingerprint sensing region 163 with the finger pulp (feature-insufficiency part) instead to capture more fingerprint feature points. Similarly, it can be deduced that after the user touches the fingerprint sensing region 163 with the left side of the finger pulp, the application processor 110 can also prompt the user to touch the fingerprint sensing region 163 with the right side of the finger pulp (feature-insufficiency part) instead to capture more fingerprint feature points.

In some embodiments, the application processor 110 can process any one of multiple fingerprint images to obtain the processing result. The application processor 110 can determine the feature-insufficiency part of this fingerprint image according to the processing result. For example, the application processor 110 can recognize the feature (processing result, such as the position of the swirl pattern in the fingerprint image) of the fingerprint image, and knows that the user uses the fingertip, the center of the finger pulp, the left side of the finger pulp or the right side of the finger pulp to touch the fingerprint sensing region 163 according to the feature. Next, the application processor 110 may display the prompt information corresponding to the feature-insufficiency part on the touch panel module 150 to notify the user to change the contact surface of the finger.

In other embodiments, the application processor 110 can determine the “feature-insufficiency part” of any one of multiple fingerprint images according to the touch result (touch information about the touch region, such as position, area size, and/or geometric shape) of the touch circuit 130. For example, when the user touches the touch panel module 150 with a fingertip, the area of the touch region of the fingertip is smaller and the long axis is shorter; when the user touches the touch panel module 150 with the finger pulp (even the entire finger), the area of the touch region of the finger pulp is larger and the long axis is longer. Therefore, the application processor 110 can determine whether the user touches the touch panel module 150 with a fingertip or the finger pulp according to the area and/or geometric shape of the touch region.

Next, the application processor 110 may display the prompt information corresponding to the feature-insufficiency part on the touch panel module 150 to notify the user to change the contact surface of the finger. For example, after the user touches the fingerprint sensing region 163 with a fingertip, the application processor 110 may also prompt the user to touch the fingerprint sensing region 163 with finger pulp (feature-insufficiency part) to capture more fingerprint feature points. Similarly, it can be inferred that after the user touches the fingerprint sensing region 163 with the finger pulp, the application processor 110 can also prompt the user to touch the fingerprint sensing region 163 with the fingertip (feature-insufficiency part) to capture more fingerprint feature points.

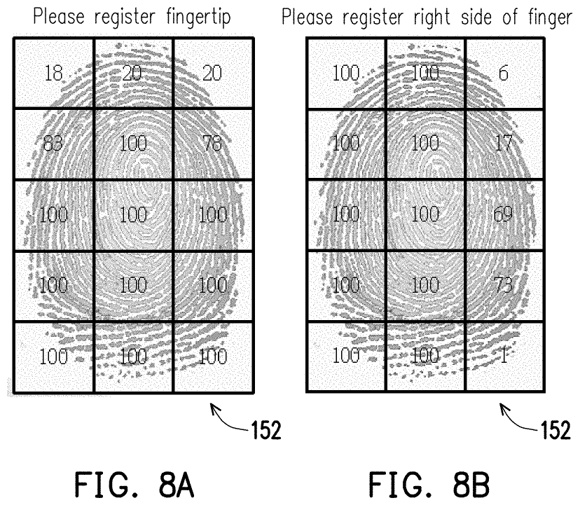

FIG. 8A and FIG. 8B are schematic diagrams illustrating pictures displayed by the touch panel module 150 shown in FIG. 1 in different application scenarios according to embodiments of the disclosure. In the embodiments shown in FIG. 8A and FIG. 8B, the touch panel module 150 has a display region 152. The application processor 110 can divide the fingerprint image into multiple statistical regions, and calculate the recognition processing progress values for these statistical regions respectively. In the embodiments shown in FIG. 8A and FIG. 8B, the fingerprint image is divided into 3*5 statistical regions.

In the application scenario shown in FIG. 8A, the user touches the fingerprint sensing region of the touch panel module 150 with his finger pulp. The application processor 110 can calculate the recognition processing progress values for the 3*5 statistical regions, and display the recognition processing progress values of these statistical regions in the display region 152 of the touch panel module 150 (as shown in FIG. 8A). The user can view the recognition processing progress values displayed in the display region 152, and find that the recognition processing progress value at the fingertip is only 20%. Therefore, the user can touch the fingerprint sensing region 163 with the fingertip (feature-insufficiency part) instead according to these recognition processing progress values to capture more fingerprint feature points. And (or), the application processor 110 can check the recognition processing progress values of these statistical regions, and then display the prompt text “please register fingertip” on the touch panel module 150 according to the recognition processing progress values to notify the user to change the contact surface of the finger.

In the application scenario shown in FIG. 8B, the user touches the fingerprint sensing region of the touch panel module 150 with the left side of the finger pulp. The application processor 110 can display the recognition processing progress values of the 3*5 statistical regions of the fingerprint image in the display region 152 of the touch panel module 150 (as shown in FIG. 8B). The user can view the recognition processing progress values displayed in the display region 152, and find that the recognition processing progress value of the right side of the fingerprint is insufficient (only 6%, 17%, 69%, 73% and 1%). Therefore, the user can touch the fingerprint sensing region 163 with the right side of the finger pulp (feature-insufficiency part) instead according to the recognition processing progress values to capture more fingerprint feature points. And (or), the application processor 110 can check the recognition processing progress values in these statistical regions, and then display the prompt text “please register the right side of the finger” on the touch panel module 150 according to the recognition processing progress values to notify the user to change the contact surface of the finger.

Based on different design requirements, the blocks of the application processor 110, the fingerprint sensing control circuit 120 and (or) the touch circuit 130 may be implemented in the form of hardware, firmware, software (i.e., program) or a combination of many of the three mentioned above.

In terms of hardware, the blocks of the application processor 110, the fingerprint sensing control circuit 120, and (or) the touch circuit 130 can be implemented on a logic circuit of an integrated circuit. The related functions of the application processor 110, the fingerprint sensing control circuit 120 and (or) the touch circuit 130 can be implemented as hardware by using hardware description languages (such as Verilog HDL or VHDL) or other suitable programming languages. For example, the related functions of the application processor 110, the fingerprint sensing control circuit 120 and (or) the touch circuit 130 can be implemented in one or more controllers, microcontrollers, microprocessors, application-specific integrated circuit (ASIC), digital signal processor (DSP), field programmable gate array (FPGA) and/or various logic blocks, modules and circuits in other processing units.

In terms of software and/or firmware, the related functions of the application processor 110, the fingerprint sensing control circuit 120 and/or the touch circuit 130 can be implemented as programming codes. For example, the application processor 110, the fingerprint sensing control circuit 120 and/or the touch circuit 130 can be implemented by using general programming languages (such as C, C++ or combined languages) or other suitable programming languages. The programming codes can be recorded/stored in a recording medium, and the recording medium, for example, includes a read only memory (ROM), a storage device, and/or a random access memory (RAM). A computer, a central processing unit (CPU), a controller, a microcontroller or a microprocessor can read and execute the programming codes from the recording medium to achieve related functions. As the recording medium, a “non-transitory computer readable medium” can be adopted, for example, tape, disk, card, semiconductor memory, programmable logic circuits, etc. Moreover, the program can also be provided to the computer (or CPU) through any transmission medium (communication network, broadcast wave, etc.) The communication network is, for example, the Internet, wired communication, wireless communication or other communication media.

In summary, the multi-fingerprint detection device 101 and the operation method thereof described in the above embodiments can determine multiple touch regions of the touch event on the touch panel module 150, and sense multiple target sub-regions corresponding to the touch regions to obtain the fingerprint sensing result. The multi-fingerprint detection device 101 can divide the fingerprint sensing result into multiple sub-fingerprint images according to these touch regions. Therefore, the multi-fingerprint detection device 101 can perform multi-fingerprint detection. The display device 100 described in the embodiments of the disclosure can display the recognition processing progress value and (or) the prompt information corresponding to the feature-insufficiency part on the touch panel module 150.

Although the present disclosure has been disclosed in the above embodiments, it is not intended to limit the present disclosure, and those skilled in the art can make some modifications and refinements without departing from the spirit and scope of the disclosure. Therefore, the scope of the present disclosure is subject to the definition of the scope of the appended claims.

1. A multi-fingerprint detection device, comprising:
a touch circuit configured to perform a touch detection control on a touch panel module to determine multiple touch regions of a touch event on the touch panel module; and
a fingerprint sensing control circuit configured to perform a fingerprint sensing control on the touch panel module, so that the touch panel module senses multiple target sub-regions corresponding to the multiple touch regions to obtain a fingerprint sensing result of the multiple target sub-regions, wherein the fingerprint sensing control circuit divides the fingerprint sensing result into multiple sub-fingerprint images according to a number of the multiple target sub-regions corresponding to the multiple touch regions.

2. The multi-fingerprint detection device according to claim 1, wherein the touch panel module comprises a touch display panel with a fingerprint sensing function.

3. The multi-fingerprint detection device according to claim 2, further comprising:
a display driving circuit configured to drive the touch display panel to display an image on the touch display panel.

4. The multi-fingerprint detection device according to claim 1, wherein a fingerprint sensing region of the touch panel module is divided into multiple sub-regions, the multi-fingerprint detection device further comprising:
an application processor, coupled to the touch circuit to receive touch information of the multiple touch regions, and coupled to the fingerprint sensing control circuit to receive the multiple sub-fingerprint images,
wherein the fingerprint sensing control circuit obtains a touch region command corresponding to the touch information from the application processor, and the fingerprint sensing control circuit selects at least one of the multiple sub-regions of the fingerprint sensing region as the multiple target sub-regions according to the touch region command.

5. The multi-fingerprint detection device according to claim 1, further comprising:
an application processor, coupled to the touch circuit to receive touch information of the multiple touch regions, and coupled to the fingerprint sensing control circuit to receive the multiple sub-fingerprint images,
wherein the fingerprint sensing control circuit obtains a touch region command corresponding to the touch information from the application processor, and the fingerprint sensing control circuit determines the multiple target sub-regions in a fingerprint sensing region of the touch panel module according to the touch region command.

6. The multi-fingerprint detection device according to claim 1, wherein a fingerprint sensing region of the touch panel module is divided into multiple sub-regions, the fingerprint sensing control circuit is coupled to the touch circuit to obtain touch information of the multiple touch regions, and the fingerprint sensing control circuit selects at least one of the multiple sub-regions of the fingerprint sensing region as the multiple target sub-regions according to the touch information of the multiple touch regions.

7. The multi-fingerprint detection device according to claim 1, wherein the fingerprint sensing control circuit is coupled to the touch circuit to obtain touch information of the multiple touch regions, and the fingerprint sensing control circuit determines the multiple target sub-regions in a fingerprint sensing region of the touch panel module according to the touch information of the multiple touch regions.

8. The multi-fingerprint detection device according to claim 1, wherein a fingerprint sensing region of the touch panel module is divided into multiple sub-regions, and at least two touch regions of the multiple touch regions overlap the same one target sub-region in the multiple target sub-regions, the fingerprint sensing control circuit calculates, according to center of gravity coordinates of the at least two touch regions, a central coordinate of the center of gravity coordinates, and the fingerprint sensing control circuit divides the fingerprint sensing result of the same target sub-region into at least two sub-fingerprint images according to the central coordinate.

9. The multi-fingerprint detection device according to claim 1, wherein a fingerprint sensing region of the touch panel module is divided into multiple sub-regions, the multi-fingerprint detection device further comprising:
an application processor, coupled to the touch circuit to receive touch information of the multiple touch regions, and coupled to the fingerprint sensing control circuit to receive the multiple sub-fingerprint images, wherein the application processor selects the multiple target sub-regions overlapped by the multiple touch regions from the multiple sub-regions of the fingerprint sensing region, and the application processor stitches the multiple sub-fingerprint images of the multiple target sub-regions overlapped by the multiple touch regions into multiple fingerprint images.

10. The multi fingerprint detection device according to claim 1, further comprising:
an application processor, coupled to the touch circuit to receive touch information of the multiple touch regions, and coupled to the fingerprint sensing control circuit to receive the multiple sub-fingerprint images, wherein the application processor stitches the multiple sub-fingerprint images into multiple fingerprint images according to the multiple touch regions.

11. The multi-fingerprint detection device according to claim 10, wherein the application processor processes any of the multiple fingerprint images to obtain a recognition processing progress value, and the application processor informs a user of the multiple recognition processing progress values of the multiple fingerprint images.

12. The multi-fingerprint detection device according to claim 11, wherein the recognition processing progress value comprises a ratio of a number of feature points of any of the multiple fingerprint images to a threshold value.

13. The multi-fingerprint detection device according to claim 10, wherein the application processor processes any of the multiple fingerprint images to obtain a processing result, the application processor determines a feature-insufficiency part of said any of the multiple fingerprint images according to the processing result, and the application processor informs a user of prompt information corresponding to the feature-insufficiency part.

14. The multi-fingerprint detection device according to claim 10, wherein the application processor determines a feature-insufficiency part of any of the multiple fingerprint images according to the touch information of the multiple touch regions, and the application processor informs a user of prompt information corresponding to the feature-insufficiency part.

15. An operation method of a multi-fingerprint detection device, comprising:
performing a touch detection control on a touch panel module to determine multiple touch regions of a touch event on the touch panel module;
performing a fingerprint sensing control on the touch panel module, so that the touch panel module senses multiple target sub-regions corresponding to the multiple touch regions, thereby obtaining a fingerprint sensing result of the multiple target sub-regions; and
dividing the fingerprint sensing result into multiple sub-fingerprint images according to a number of the multiple target sub-regions corresponding to the multiple touch regions.

16. The operation method according to claim 15, wherein the touch panel module comprises a touch display panel with a fingerprint sensing function.

17. The operation method according to claim 16, further comprising:
driving the touch display panel to display an image on the touch display panel.

18. The operation method according to claim 15, further comprising:
dividing a fingerprint sensing region of the touch panel module into multiple sub-regions;
receiving, by a touch circuit of an application processor, touch information of the multiple touch regions; and
selecting, by a fingerprint sensing control circuit, at least one of the multiple sub-regions of the fingerprint sensing region as the multiple target sub-regions according to a touch region command corresponding to the touch information.

19. The operation method according to claim 15, further comprising:
receiving, by a touch circuit of an application processor, touch information of the multiple touch regions; and
determining, by a fingerprint sensing control circuit, the multiple target sub-regions in a fingerprint sensing region of the touch panel module according to a touch region command corresponding to the touch information.

20. The operation method according to claim 15, further comprising:
dividing a fingerprint sensing region of the touch panel module into multiple sub-regions; and
selecting at least one of the multiple sub-regions of the fingerprint sensing region as the multiple target sub-regions according to touch information of the multiple touch regions.

21. The operation method according to claim 15, further comprising:
determining the multiple target sub-regions in a fingerprint sensing region of the touch panel module according to touch information of the multiple touch regions.

22. The operation method according to claim 15, further comprising:
dividing a fingerprint sensing region of the touch panel module into multiple sub-regions;
when at least two touch regions of the multiple touch regions overlap the same one target sub-region in the multiple target sub-regions, calculating, according to center of gravity coordinates of the at least two touch regions, a central coordinate of the center of gravity coordinates, and dividing the fingerprint sensing result of the same target sub-region into at least two sub-fingerprint images according to the central coordinate.

23. The operation method according to claim 15, further comprising:
dividing a fingerprint sensing region of the touch panel module into multiple sub-regions;
selecting the multiple target sub-regions overlapped by the multiple touch regions from the multiple sub-regions of the fingerprint sensing region; and
stitching the multiple sub-fingerprint images of the multiple target sub-regions overlapped by the multiple touch regions into multiple fingerprint images.

24. The operation method according to claim 15, further comprising:
stitching the multiple sub-fingerprint images into multiple fingerprint images according to the multiple touch regions.

25. The operation method according to claim 24, further comprising:
processing any one of the multiple fingerprint images to obtain a recognition processing progress value; and
informing a user of the multiple recognition processing progress values of the multiple fingerprint images.

26. The operation method according to claim 25, wherein the recognition processing progress value comprises a ratio of a number of feature points of any of the multiple fingerprint images to a threshold value.

27. The operation method according to claim 24, further comprising:
processing any one of the multiple fingerprint images to obtain a processing result;
determining a feature-insufficiency part of said any one of the multiple fingerprint images according to the processing result; and
informing a user of prompt information corresponding to the feature-insufficiency part.

28. The operation method according to claim 24, further comprising:
determining a feature-insufficiency part of any one of the multiple fingerprint images according to the touch information of the multiple touch regions; and
informing a user of prompt information corresponding to the feature-insufficiency part.

29. A display device, comprising:
a touch panel module;
a display driving circuit configured to drive the touch panel module to display an image on the touch panel module;
a touch circuit configured to perform a touch detection control on the touch panel module to determine at least one touch region of a touch event on the touch panel module;
a fingerprint sensing control circuit configured to perform a fingerprint sensing control on the touch panel module, so that the touch panel module senses multiple target sub-regions corresponding to the at least one touch region to obtain at least one fingerprint sensing result of the multiple target sub-regions, wherein the fingerprint sensing control circuit divides the at least one fingerprint sensing result into multiple sub-fingerprint images according to a number of the multiple target sub-regions corresponding to the at least one touch region; and
an application processor coupled to the fingerprint sensing control circuit to receive the at least one fingerprint sensing result, wherein the application processor processes the at least one fingerprint sensing result to obtain a recognition processing progress value, and the application processor displays the recognition processing progress value of the at least one fingerprint sensing result on the touch panel module through the display driving circuit.

30. The display device according to claim 29, wherein the recognition processing progress value comprises a ratio of a number of feature points of the at least one fingerprint sensing result to a threshold value.

31. The display device according to claim 29, wherein the application processor processes the at least one fingerprint sensing result to obtain a processing result, the application processor determines a feature-insufficiency part of a fingerprint image corresponding to the at least one fingerprint sensing result according to the processing result, and the application processor displays prompt information corresponding to the feature-insufficiency part on the touch panel module through the display driving circuit.

32. The display device according to claim 29, further comprising:
wherein the application processor determines a feature-insufficiency part of a fingerprint image corresponding to the at least one fingerprint sensing result according to the at least one touch region, and the application processor displays prompt information corresponding to the feature-insufficiency part on the touch panel module through the display driving circuit.

33. A display device, comprising:
a touch panel module;
a display driving circuit configured to drive the touch panel module to display an image on the touch panel module;
a touch circuit configured to perform a touch detection control on the touch panel module to determine at least one touch region of a touch event on the touch panel module;
a fingerprint sensing control circuit configured to perform a fingerprint sensing control on the touch panel module, so that the touch panel module senses multiple target sub-regions corresponding to the at least one touch region to obtain at least one fingerprint sensing result of the multiple target sub-regions, wherein the fingerprint sensing control circuit divides the at least one fingerprint sensing result into multiple sub-fingerprint images according to a number of the multiple target sub-regions corresponding to the at least one touch region; and an application processor, coupled to the touch circuit to receive touch information of the at least one touch region, and coupled to the fingerprint sensing control circuit to receive the at least one fingerprint sensing result, wherein the application processor determines a feature-insufficiency part of the at least one fingerprint sensing result according to the at least one touch region, and the application processor displays prompt information corresponding to the feature-insufficiency part on the touch panel module through the display driving circuit.
